(19) United States
(12) Patent Application Publication
(10) Pub. No.: US 2024/0055632 A1
(43) Pub. Date: Feb. 15, 2024

(54) Device and Method for Checking the Inertization State of a Fuel Provision System

(71) Applicant: Bayerische Motoren Werke Aktiengesellschaft, Muenchen (DE)

(72) Inventor: Heiko WALTHER, Velden (DE)

(21) Appl. No.: 18/549,082

(22) PCT Filed: Feb. 15, 2022
(86) PCT No.: PCT/EP2022/053658

§ 371 Date: Sep. 5, 2023

(30) Foreign Application Priority Data
Mar. 11, 2021 (DE) 10 2021 105 899.6

(51) Int. Cl. H01M 8/0438; H01M 8/04746; H01M 8/04537

(52) U.S. Cl. CPC H01M 8/0438; H01M 8/04753; H01M 8/04552; H01M 8/04582; H01M 8/04432; H01M 2250/20

(57) ABSTRACT

An apparatus for determining state information relating to inertization of a fuel provision system configured to supply a fuel cell unit with fuel and including a vessel for storing fuel and a fuel line between the vessel and/or between a refueling access for refueling the vessel and the fuel cell unit, where the inertization replaces fuel in the fuel line and/or in the fuel cell unit with inert gas. The apparatus includes a device that is configured to cause the fuel cell unit to be supplied with gas from the fuel line while the vessel is closed and/or without fuel being taken from the vessel, to determine measurement information relating to an electric current and/or an electric voltage caused by the fuel cell unit being supplied with gas, and to determine the state information relating to the inertization of the fuel provision system on a basis of the measurement information.

### BACKGROUND AND SUMMARY OF THE INVENTION

The technology disclosed here relates to a vehicle having a fuel cell unit for generating electric energy for an electric drive machine of the vehicle, wherein the fuel cell unit is supplied with fuel from a fuel provision system of the vehicle. In particular, the invention relates to a method and a device for checking the inertization of the fuel provision system of a vehicle.

An electrically driven vehicle may have a fuel cell unit with one or more fuel cells which is configured to generate, on the basis of a fuel, in particular on the basis of hydrogen, electric energy for operating the electric drive machine of the vehicle. The fuel for the fuel cell unit is provided by a fuel provision system of the vehicle, wherein the fuel provision system typically has one or more vessels, in particular pressure vessels and/or cryogenic vessels, for storing the fuel.

In preparation for a maintenance measure on the fuel provision system and/or on the fuel cell unit, it may be necessary to inertize the fuel provision system, wherein fuel in the fuel provision system, in particular in one or more lines of the fuel provision system, is replaced with an inert gas during inertization of the fuel provision system.

The inertization of a fuel provision system is typically a manual or partially automated process which is carried out by a service employee, for example. When carrying out the manual inertization process, operating errors by the service employee and possibly inadequate inertization of the fuel provision system may occur.

DE 11 2004 001 715 T5 and EP 3 324 475 A1 each describe a method for switching a fuel cell on and off. DE 37 32 234 A1 describes a method for removing inert gas from a fuel cell. US 2007/003805 A1 describes a method for switching off a fuel cell.

One preferred object of the technology disclosed here is to reduce or eliminate at least one disadvantage of a previously known solution or to propose an alternative solution. One preferred object of the technology disclosed here is to make it possible to efficiently, reliably and safely inertize a fuel provision system.

The object(s) is/are each achieved by means of the subject matter of the independent patent claims. The dependent claims describe preferred configurations.

One aspect describes a device for determining state information relating to the inertization of a fuel provision system with an inert gas. In this case, the fuel provision system may be configured to supply a fuel cell unit with fuel. The fuel cell unit may have, for example, a fuel cell stack having one or more fuel cells. The fuel cell unit may be configured to generate electric energy on the basis of the fuel. The fuel may comprise hydrogen or may be hydrogen, in particular H₂ or compressed gaseous hydrogen (CGH2). The fuel cell unit is intended, for example, for mobile applications such as motor vehicles (for example automobiles, motorcycles, commercial vehicles), in particular for providing the energy for at least one drive machine for moving the motor vehicle. In its simplest form, a fuel cell is an electrochemical energy converter which converts fuel (for example hydrogen) and oxidizing agents (for example, air, oxygen and/or peroxides) into reaction products and in the process produces electricity and heat.

The fuel provision system may comprise at least one vessel, in particular a pressure vessel, for storing fuel. The vessel may be designed to store fuel which is gaseous under ambient conditions. The fuel provision system may be used, for example, in a motor vehicle which is operated using compressed natural gas (also called CNG) or liquid natural gas (also called LNG) or hydrogen as the fuel. The fuel provision system typically comprises one or more fuel lines which are designed to conduct fuel from the at least one vessel and/or from a refueling access (in particular from a refueling coupling) of the fuel provision system to the fuel cell unit.

The vessel of the fuel provision system may be a composite overwrapped pressure vessel, a cryogenic pressure vessel and/or a high-pressure gas vessel. High-pressure gas vessels are designed to permanently store fuel, at ambient temperatures, at a nominal working pressure (also called NWP) of at least 350 barg (=overpressure compared with atmospheric pressure) or at least 700 barg. A cryogenic pressure vessel is suitable for storing the fuel at the above-mentioned working pressures even at temperatures well below (for example more than 50 Kelvin or more than 100 Kelvin) the working temperature of the motor vehicle.

The inertization of the fuel provision system may be designed to replace the fuel in the fuel provision system and/or the fuel cell unit with an inert gas (in particular with nitrogen) (apart from the fuel in the one or more pressure vessels of the fuel provision system). In other words, in an inertization process, the fuel arranged outside the one or more pressure vessels may be caused to be replaced substantially completely (for example up to 99% or more or up to 99.9% or more) with the inert gas. This makes it possible to safely maintain the fuel provision system and/or the fuel cell unit. The device described in this document is configured to check whether the fuel provision system is actually in the inert state (in which, for example, 99% or more of the fuel has been replaced with the inert gas).

The device is configured to cause the fuel cell unit to be supplied with gas from the fuel provision system. In this case, it is possible, in particular, to cause the fuel cell unit to be provided (possibly exclusively) with gas from the one or more fuel lines. Alternatively or additionally, it is possible to cause the fuel cell unit to be provided with gas while the pressure vessel is closed and/or without fuel being taken from the (or any) pressure vessel. It is thus possible to cause the fuel cell unit to be supplied, in particular flushed, with the gas which is outside any pressure vessel of the fuel provision system in the fuel provision system.

The device may also be configured to determine measurement information relating to the electric current and/or the electric voltage caused by the fuel cell unit being supplied (in particular flushed) with gas from the fuel provision system. It is therefore possible to determine whether the gas from the fuel provision system causes a voltage and/or a current in the fuel cell unit (which indicates that the gas still has fuel). The measurement information can be determined or captured using a current and/or voltage measurement unit of the fuel cell unit.

The device is also configured to determine the state information relating to the inertization of the fuel provision system on the basis of the measurement information. In this case, it is possible to determine in particular, on the basis of the measurement information, state information indicating the concentration of fuel in the gas from the fuel provision system. Alternatively or additionally, the state information may indicate the degree of inertization of the fuel provision system. Alternatively or additionally, the state information may indicate whether or not the fuel provision system is in an inert state. Alternatively or additionally, the state information may indicate whether the gas from the fuel provision system has a concentration of fuel which is equal to or less than a predefined concentration threshold value (for example 1% or 0.1%).

Therefore, after carrying out an inertization process, it is possible to determine state information relating to the actual inertization state of the fuel provision system. This makes it possible to maintain the fuel provision system in a particularly safe manner.

The device may be configured to effect a measure with respect to the inertization of the fuel provision system, wherein the measure depends on the determined state information. In this case, the measure may comprise the output of information, for example the output of information relating to whether or not the fuel provision system is in an inert state, and/or the output of information relating to the concentration of fuel in the gas from the fuel provision system. The safety with which the fuel provision system is maintained can therefore be increased further.

The device may be configured to determine whether an inertization process of the fuel provision system has been carried out. As already stated above, the inertization process may be designed to replace fuel in the one or more fuel lines of the fuel provision system and/or in the fuel cell unit (substantially completely, for instance up to 99% or more or up to 99.9% or more) with the inert gas. For example, a query regarding whether an inertization process has been carried out can be sent to a user via a user interface. It is then possible to determine, on the basis of a user input in response to the query, whether or not an inertization process has been carried out.

The device may be configured to cause the fuel cell unit to be supplied with gas from the fuel provision system, in order to determine the state information, (possibly only) when it has been determined that an inertization process of the fuel provision system has previously been carried out. In other words, the check of the inertization state that is described in this document can be selectively carried out (possibly only) when it has been determined that an inertization process has previously been carried out. This makes it possible to determine the inertization state in a particularly safe and reliable manner.

The device may be configured to determine measurement information relating to the level of the electric voltage and/or the level or the intensity of the electric current. State information indicating the concentration of fuel in the gas from the fuel provision system can then be determined in a particularly precise manner on the basis of the measurement information (in particular on the basis of the voltage level or the current intensity).

The device may be configured to determine measurement information relating to the presence of fuel in the exhaust gas of the fuel cell unit, which is caused by the fuel cell unit being supplied with gas from the fuel provision system. In this case, the measurement information may indicate, in particular, the concentration and/or amount of fuel in the exhaust gas of the fuel cell unit. The measurement information may be determined using an exhaust gas and/or fuel sensor of the fuel cell unit.

The state information may then also be determined in a particularly precise manner on the basis of the measurement information relating to the presence of fuel in the exhaust gas of the fuel cell unit. In particular, state information indicating the concentration of fuel in the gas from the fuel provision system may be determined on the basis of the measurement information.

A further aspect describes a further device for determining state information relating to the inertization of a fuel provision system with an inert gas. The measures described in this document can also be applied to this device.

The device is configured to cause the fuel cell unit to be supplied with gas from the fuel provision system. The device may also be configured to determine measurement information relating to the presence of fuel in the exhaust gas of the fuel cell unit, which is caused by the fuel cell unit being supplied with gas from the fuel provision system. The device is also configured to determine the state information relating to the inertization of the fuel provision system on the basis of the measurement information.

A further aspect describes a (road) motor vehicle (in particular an automobile or a truck or a bus or a motorcycle) which comprises the device described in this document. The vehicle may have, in particular, an electric drive motor for driving the vehicle. The vehicle may also comprise a fuel cell unit which is configured to generate, on the basis of a fuel, electric current for operating the drive motor. The vehicle may also comprise a fuel provision system which is configured to supply the fuel cell unit with fuel.

A further aspect describes a method for determining state information relating to the inertization of a fuel provision system with an inert gas. The fuel provision system is configured to supply a fuel cell unit with fuel. The method comprises causing the fuel cell unit to be supplied with gas from the fuel provision system. The method also comprises determining measurement information relating to the electric current and/or the electric voltage caused by the fuel cell unit being supplied with gas from the fuel provision system. Alternatively or additionally, the method comprises determining measurement information relating to the presence of fuel in the exhaust gas of the fuel cell unit, which is caused by the fuel cell unit being supplied with gas from the fuel provision system. The method also comprises determining state information relating to the inertization of the fuel provision system on the basis of the measurement information.

A further aspect describes a software (SW) program. The SW program may be configured to be executed on a processor (for example on a control unit of a vehicle) and to thereby carry out the method described in this document.

A further aspect describes a storage medium. The storage medium may comprise a SW program which is configured to be executed on a processor and to thereby carry out the method described in this document.

It should be noted that the methods, devices and systems described in this document can be used both alone and in combination with other methods, devices and systems described in this document. Furthermore, any aspects of the methods, devices and systems described in this document can be combined with one another in various ways. In particular, the features of the claims can be combined with one another in various ways.

The invention is described in more detail below on the basis of exemplary embodiments.

### BRIEF DESCRIPTION OF THE DRAWINGS

FIG. 1a shows an exemplary vehicle having a fuel provision system;

FIG. 1b shows an exemplary fuel provision system; and

FIGS. 2a and 2b show flowcharts of exemplary methods for determining state information relating to the inertization of a fuel provision system.

### DETAILED DESCRIPTION OF THE DRAWINGS

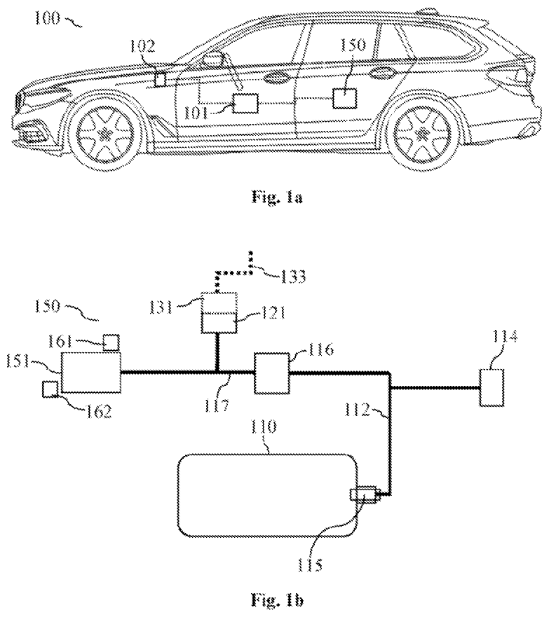

As stated at the outset, the present document deals with the efficient and reliable inertization of a fuel provision system. In this context, FIG. 1a shows an exemplary vehicle 100 having a fuel provision system 150 which is designed to supply a fuel cell unit of the vehicle 100 (which is possibly part of the fuel provision system 150) with a fuel, in particular with hydrogen or H₂. The vehicle 100 also comprises a (monitoring) device 101 which is configured to determine state information relating to a state of the fuel provision system 150. The state may relate to the inertization, in particular the degree of inertization, of the fuel provision system 150.

The device 101 may also be configured to effect a measure with respect to the fuel provision system 150, for instance a protective measure for protecting the fuel provision system 150, on the basis of the determined state information. For example, a user interface 102 of the vehicle 100 may be used to indicate whether or not the fuel provision system 150 has a sufficiently high degree of inertization.

FIG. 1b shows an exemplary fuel provision system 150. The fuel provision system 150 typically comprises a pressure vessel 110 which can be used to store fuel (in particular hydrogen) for the fuel cell unit 151. The pressure vessel 110 is connected to the fuel cell unit 151 via at least one fuel line 112, 117.

The pressure vessel 110 has a controllable valve 115 which can be used to conduct fuel from the pressure vessel 110 into the fuel line 112. The valve 115 of the pressure vessel 110 is typically closed in an idle state, with the result that no fuel can escape from the pressure vessel 110 via the valve 115. The valve 115 of the pressure vessel 110 be designed to be opened in response to a control signal, for instance a control signal from the device 101.

The pressure vessel 110 may be refueled with fuel via a refueling access 114 (for example via a tank receptacle). In particular, fuel may be conveyed from a fuel pump, via the fuel line 112, into the pressure vessel 110 via the refueling access 114.

The fuel cell unit 151 is typically operated at a relatively low working pressure (for example in the range of 10-20 barg), in which case the low pressure for the fuel cell unit 151 is usually substantially below the high pressure (for example in the region of 700 barg) in the fuel line 112 and in the pressure vessel 110. A pressure transducer 116 (in particular a pressure controller) may therefore be arranged between the pressure vessel 110 and the fuel cell 101 and is configured to transfer fuel from the high-pressure fuel line 112 (which has a relatively high pressure) into a low-pressure fuel line 117 (with a relatively low pressure). The fuel is then conducted to the fuel cell unit 151 via the low-pressure fuel line 117.

Fuel from the pressure vessel 110 may reach the fuel line 112, 117 by opening the valve 115 of the pressure vessel 110. The fuel provision system 150 may have a relief valve 121 which can be used to discharge fuel from the fuel line 112, 117 into an environment of the fuel provision system 150, in particular into an environment of the vehicle 100. In particular, a relief hose 133 outside the vehicle may be connected to the relief valve 121 by means of a coupling element 131. The relief valve 121 may be opened by coupling the relief hose 133, with the result that fuel can be discharged from the fuel provision system 150.

Before maintenance work on the fuel provision system 150, it may be necessary to inertize the fuel provision system 150 or change it to an inert state. The inert state can be achieved, for example, if the proportion of fuel, in particular H₂, in the components outside the pressure vessel 110, in particular in the one or more fuel lines 112, 117, is equal to or less than a predefined concentration threshold value (for instance of 0.1%).

The fuel provision system 150 may be inertized in such a manner that
1) the gas pressure in the fuel provision system 150 (outside the pressure vessel 110), that is to say in particular in the one or more fuel lines 112, 117 and/or in the fuel cell unit 151, is reduced, for example to 0 barg; for this purpose, the relief valve 121, for example, may be opened in order to discharge gas from the fuel provision system 150; alternatively or additionally, the gas may be conducted from the fuel provision system 150 via the fuel cell unit 151; and then
2) an inert gas, for example nitrogen, is conducted into the fuel provision system 150 and the gas pressure in the fuel provision system 150 (outside the pressure vessel 110) is increased again, for example to 15 barg. In this case, the inert gas may be supplied via the refueling access 114.

The above-mentioned steps are a cycle of the inertization process, in which case the concentration of fuel in the provision system (outside the pressure vessel 110) can be reduced by a particular factor, for example by a factor of 10, in a cycle. The inertization process may have a plurality of cycles in order to iteratively cause the fuel concentration in the provision system (outside the pressure vessel 110) to reach or fall below the concentration threshold value.

During service work on an H₂ tank system 150, it may be necessary to change the tank system 150 to a safe and/or inert state. In this case, the hydrogen is replaced with a non-combustible (inert) gas. This inertization can be initiated and/or effected by a diagnostic job.

During inertization, the H₂ system 150 is relieved to 0 bar and is then pressurized with the inert gas (for example nitrogen) to a pressure of 15 bar, for example. The pressure is then completely relieved again and the system is pressurized again with the inert gas (for example nitrogen) to a pressure of 15 bar, for example.

This process is repeated, for example, until the hydrogen in the system 150 has been diluted below a particular concentration threshold value (for example 1 per mil) and therefore can no longer react with other substances. The concentration threshold value may be equal to or less than a lower explosion limit of hydrogen.

However, performing the diagnostic job cannot exclude incorrect operation by a service employee and the freedom from hydrogen therefore cannot be guaranteed. This document describes a diagnostic method for diagnosing the gas in the system 150, which can be used to guarantee that the H₂ system 150 is “hydrogen-free”.

In order to check the inertization state of the fuel provision system 150, the device 101 may be configured to cause gas from the fuel provision system 150, particular gas from the fuel line 112, 117, to be flushed through the fuel cell unit 151. In other words, it is possible to cause the fuel cell unit 151 to be operated with gas from the fuel provision system 150, in particular with gas from the fuel line 112, 117.

Flushing the fuel cell unit 151 with gas from the fuel provision system 150 results in the fuel that remains in the gas causing a chemical reaction in the fuel cell unit 151, which chemical reaction in turn results in a voltage drop across the fuel cell unit 151 and/or in a current flow through the fuel cell unit 151. The presence of fuel inside the gas from the fuel provision system 150 can therefore be detected using a voltage and/or current measurement unit 161 for measuring the electric voltage at the fuel cell unit 151 and/or the electric current through the fuel cell unit 151. In this case, the level of the voltage and/or the intensity of the current typically depend(s) on the concentration of fuel in the gas from the fuel provision system 150.

The device 101 may therefore be configured to determine measurement information relating to the voltage and/or the current in the fuel cell unit 151 (for example using the voltage and/or current measurement unit 161). The state of the fuel provision system 150 with respect to the inertization can then be reliably determined on the basis of the measurement information.

Alternatively or additionally, the fuel provision system 150 may comprise an exhaust gas sensor 162 which is configured to capture measurement information relating to the presence of fuel in the exhaust gas of the fuel cell unit 151. The device 101 may be configured to determine the state of the fuel provision system 150 with respect to the inertization on the basis of the measurement information relating to the exhaust gas of the fuel cell unit 151.

The state of the fuel provision system 150 with respect to the inertization can therefore be efficiently and reliably determined on the basis of the measurement information from the voltage and/or current measurement unit 161 and/or the exhaust gas sensor 162. In particular, the degree of inertization, for instance the remaining concentration of fuel in the fuel provision system 150, may be determined. Depending on the determined inertization state of the fuel provision system 150, a measure may then possibly be effected, for example in order to prompt the user of the fuel provision system 150 to continue the inertization process or to inform the user that the fuel provision system 150 is in an inert state. Particularly safe operation of the fuel provision system 150 can therefore be enabled.

In order to analyze whether the H₂ system 150 has been adequately flushed, the fuel cell unit 151 can therefore be flushed with the gas in the H₂ system 150. If there is no longer any hydrogen in the gas, the fuel cell unit 151 does not generate a voltage. This can be measured and reported back by the control unit 101 of the system 150. Alternatively or additionally, a hydrogen sensor 162 may be arranged in the exhaust gas line of the fuel cell unit 151. This may be used as a measurement variable for detecting residual hydrogen. It is therefore possible to provide a diagnostic function which (in response to the fuel cell unit 151 being flushed with gas) measures the cell voltage and the H₂ concentration in the exhaust gas. The measured values can then be evaluated and feedback relating to the evaluation can be provided (for example via a user interface 102).

In order to determine the state information, the device 101 may cause all required valves to be switched in order to flush the fuel cell unit 151 with the gas from the H₂ system 150 (which is arranged outside the one or more pressure vessels 110). Evaluating the cell voltage and/or the hydrogen sensor 162 in the exhaust air makes it possible to detect whether or not there is still hydrogen in the gas. If there is still hydrogen in the H₂ system 150, the fuel cell unit 151 generates a measurable voltage via its one or more fuel cells. At the same time, a concentration of hydrogen can be detected at the hydrogen sensor 162 in the exhaust air system.

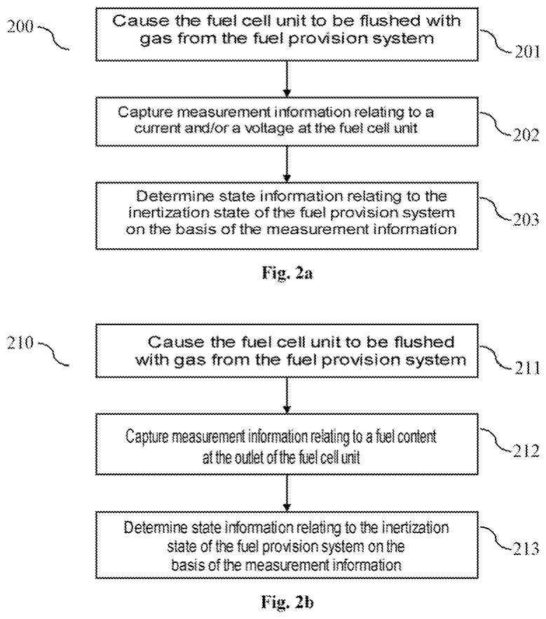

FIG. 2a shows a flowchart of an exemplary (possibly computer-implemented) method 200 for determining state information relating to the inertization of a fuel provision system 150 (which is possibly part of a vehicle 100) with an inert gas (for example nitrogen). As stated in this document, the fuel provision system 150 is configured to supply a fuel cell unit 151 (for example a fuel cell stack) with a (gaseous) fuel (in particular H₂).

The method 200 comprises causing 201 the fuel cell unit 151 to be supplied, in particular flushed, with gas from the fuel provision system 150, in particular with gas from the one or more fuel lines 112, 117 of the fuel provision system 150 (without fuel being taken from any pressure vessel 110 of the fuel provision system 150). After successful inertization, the gas made available to the fuel cell unit 151 should be substantially (at least up to 99% or more) the inert gas.

The method 200 also comprises determining 202 measurement information relating to the electric current and/or the electric voltage caused by the fuel cell unit 151 being supplied with gas from the fuel provision system 150. The measurement information may be determined using a current and/or voltage measurement unit 161 of the fuel cell unit 151. The measurement information may indicate, in particular, whether and possibly how strong the voltage is that is caused by the fuel cell unit 151 being flushed with the gas from the (inert) fuel provision system 150.

The method 200 also comprises determining 203 state information relating to the inertization of the fuel provision system 150 on the basis of the measurement information. In this case, the state information may indicate, in particular, whether or not the fuel provision system 150 is in an inert (safe) state.

FIG. 2b shows a flowchart of a further exemplary (possibly computer-implemented) method 210 for determining state information relating to the inertization of a fuel provision system 150 with an inert gas (for example nitrogen). The methods 200, 210 may be combined with one another in any desired manner.

The method 210 comprises causing 211 the fuel cell unit 151 to be supplied, in particular flushed, with gas from the fuel provision system 150, in particular with gas from the one or more fuel lines 112, 117 of the fuel provision system 150 (without fuel being taken from any pressure vessel 110 of the fuel provision system 150).

The method 210 also comprises determining 212 measurement information relating to the presence of fuel in the exhaust gas of the fuel cell unit 151, which is caused by the fuel cell unit 151 being supplied with gas from the fuel provision system 150. The measurement information may be determined using a fuel and/or exhaust gas sensor 162 of the fuel cell unit 151.

The method 210 also comprises determining 213 state information relating to the inertization of the fuel provision system 150 on the basis of the measurement information. In this case, the state information may indicate, in particular, whether or not the fuel provision system 150 is in an inert (safe) state.

The measures described in this document make it possible to reliably determine the inertization state of a fuel provision system 150, as a result of which the safety of maintenance work on the fuel provision system 150 can be increased.

The present invention is not restricted to the exemplary embodiments shown. In particular, it should be noted that the description and the figures are intended to illustrate, only by way of example, the principle of the proposed methods, devices and systems.

### LIST OF REFERENCE CHARACTERS

100 Vehicle
101 (Control) device
102 User interface
110 Pressure vessel
112, 117 Fuel line
114 Refueling access
115 Pressure vessel valve
116 Pressure transducer
121 Relief valve
131 Coupling element
133 Relief hose
150 Fuel provision system
151 Fuel cell unit
161 Voltage and/or current measurement unit
162 Exhaust gas and/or fuel sensor
200 Method for determining the inertization state
201-203 Method steps
210 Method for determining the inertization step
211-213 Method steps

1.-12. (canceled)

13. An apparatus for determining state information relating to inertization of a fuel provision system with an inert gas, wherein the fuel provision system is configured to supply a fuel cell unit with fuel, wherein the fuel provision system comprises a vessel for storing fuel and at least one fuel line between the vessel and/or between a refueling access for refueling the vessel and the fuel cell unit, and wherein the inertization of the fuel provision system is designed to replace fuel in the at least one fuel line and/or in the fuel cell unit with the inert gas, comprising:
a device configured to:
cause the fuel cell unit to be supplied with gas from the at least one fuel line while the vessel is closed and/or without fuel being taken from the vessel;
determine measurement information relating to an electric current and/or an electric voltage caused by the fuel cell unit being supplied with gas from the at least one fuel line; and
determine the state information relating to the inertization of the fuel provision system on a basis of the measurement information, wherein the state information indicates:
a concentration of fuel in the gas from the fuel provision system; and/or
whether the gas from the fuel provision system has a concentration of fuel that is equal to or less than a predefined concentration threshold value.

14. The apparatus according to claim 13, wherein the device is configured to:
determine whether an inertization process of the fuel provision system has been carried out, which inertization process is designed to replace fuel in the at least one fuel line of the fuel provision system and/or in the fuel cell unit with the inert gas; and
cause the fuel cell unit to be supplied with gas from the at least one fuel line, in order to determine the state information, when it has been determined that an inertization process of the fuel provision system has previously been carried out.

15. The apparatus according to claim 13, wherein the device is configured to determine, on the basis of the measurement information, state information indicating:
a degree of inertization of the fuel provision system; and/or
whether or not the fuel provision system is in an inert state.

16. The apparatus according to claim 13, wherein:
the device is configured to effect a measure with respect to the inertization of the fuel provision system; and
the measure depends on the determined state information.

17. The apparatus according to claim 16, wherein the measure comprises output of information:
relating to whether or not the fuel provision system is in an inert state; and/or
relating to a concentration of fuel in the gas from the fuel provision system.

18. The apparatus according to claim 13, wherein the device is configured to:
determine measurement information relating to a level of the electric voltage and/or the electric current; and
determine, on the basis of the measurement information, state information indicating the concentration of fuel in the gas from the fuel provision system.

19. The apparatus according to claim 13, wherein the device is configured to:
determine measurement information relating to a presence of fuel in the exhaust gas of the fuel cell unit, which is caused by the fuel cell unit being supplied with gas from the fuel provision system; and
determine the state information on the basis of the measurement information relating to the presence of fuel in the exhaust gas of the fuel cell unit.

20. The apparatus according to claim 19, wherein the device is configured to:
determine measurement information indicating a concentration and/or an amount of fuel in the exhaust gas of the fuel cell unit; and
determine, on the basis of the measurement information, state information indicating the concentration of fuel in the gas from the fuel provision system.

21. An apparatus for determining state information relating to inertization of a fuel provision system with an inert gas, wherein the fuel provision system is configured to supply a fuel cell unit with fuel, wherein the fuel provision system comprises a vessel for storing fuel and at least one fuel line between the vessel and/or between a refueling access for refueling the vessel and the fuel cell unit, and wherein the inertization of the fuel provision system is designed to replace fuel in the at least one fuel line and/or in the fuel cell unit with the inert gas, comprising:
a device configured to:
cause the fuel cell unit to be supplied with gas from the at least one fuel line while the vessel is closed and/or without fuel being taken from the vessel;
determine measurement information relating to a presence of fuel in the exhaust gas of the fuel cell unit, which is caused by the fuel cell unit being supplied with gas from the at least one fuel line; and
determine the state information relating to the inertization of the fuel provision system on a basis of the measurement information, wherein the state information indicates:
a concentration of fuel in the gas from the fuel provision system; and/or
whether the gas from the fuel provision system has a concentration of fuel that is equal to or less than a predefined concentration threshold value.

22. A motor vehicle, comprising:
an electric drive motor for driving the motor vehicle;
a fuel cell unit which is configured to generate, on a basis of a fuel, electric current for operating the electric drive motor;
a fuel provision system which is configured to supply the fuel cell unit with fuel; and
a device for determining state information relating to inertization of the fuel provision system with an inert gas, wherein the device is configured according to claim 13.

23. A method for determining state information relating to inertization of a fuel provision system with an inert gas, wherein the fuel provision system is configured to supply a fuel cell unit with fuel, wherein the fuel provision system comprises a vessel for storing fuel and at least one fuel line between the vessel and/or between a refueling access for refueling the vessel and the fuel cell unit, and wherein the inertization of the fuel provision system is designed to replace fuel in the at least one fuel line and/or in the fuel cell unit with the inert gas, the method comprising the steps of:
causing the fuel cell unit to be supplied with gas from the at least one fuel line while the vessel is closed and/or without fuel being taken from the vessel;
determining measurement information relating to an electric current and/or an electric voltage caused by the fuel cell unit being supplied with gas from the at least one fuel line; and
determining state information relating to the inertization of the fuel provision system on a basis of the measurement information, wherein the state information indicates:
a concentration of fuel in the gas from the fuel provision system; and/or
whether the gas from the fuel provision system has a concentration of fuel that is equal to or less than a predefined concentration threshold value.

24. A method for determining state information relating to inertization of a fuel provision system with an inert gas, wherein the fuel provision system is configured to supply a fuel cell unit with fuel, wherein the fuel provision system comprises a vessel for storing fuel and at least one fuel line between the vessel and/or between a refueling access for refueling the vessel and the fuel cell unit, and wherein the inertization of the fuel provision system is designed to replace fuel in the at least one fuel line and/or in the fuel cell unit with the inert gas, the method comprising the steps of:
causing the fuel cell unit to be supplied with gas from the at least one fuel line while the vessel is closed and/or without fuel being taken from the vessel;
determining measurement information relating to a presence of fuel in the exhaust gas of the fuel cell unit, which is caused by the fuel cell unit being supplied with gas from the at least one fuel line; and
determining state information relating to the inertization of the fuel provision system on a basis of the measurement information, wherein the state information indicates:
a concentration of fuel in the gas from the fuel provision system; and/or
whether the gas from the fuel provision system has a concentration of fuel that is equal to or less than a predefined concentration threshold value.
